(19) United States
(12) Patent Application Publication
(10) Pub. No.: US 2005/0257318 A1
(43) Pub. Date: Nov. 24, 2005

(54) Bath apparatus

(76) Inventor: Nia Perkins, Fontana, CA (US)

Correspondence Address: JAMES RAY & ASSOCIATES, 2640 PITCAIRN ROAD, MONROEVILLE, PA, 15146, US

(21) Appl. No.: 11/133,055

(22) Filed: May 19, 2005

Related U.S. Application Data
(60) Provisional application No. 60/572,959, filed on May 19, 2004.

(51) Int. Cl. A47K 3/022; A61H 35/00; E03C 1/00

(52) U.S. Cl. 4/622

(57) ABSTRACT

An apparatus for at least one of bathing and soaking a body part. The apparatus includes a bath chamber for containing a fluid and receiving such body part therein. The bath chamber having a bottom surface and a wall structure extending upwardly therefrom. A glitter like material is disposed on at least one of such bottom surface, an inner surface of such wall structure and a combination thereof of the bath chamber.

### CROSS REFERENCE TO RELATED APPLICATIONS

This application is related to and claims priority from U.S. Provisional Patent Application Ser. No. 60/572,959 filed May 20, 2004.

### FIELD OF THE INVENTION

This invention relates, in general, to equipment for soothing the feet and, more particularly, this invention relates to an apparatus for soothing the feet which includes a means for making the apparatus more pleasing to view during a use thereof.

### BACKGROUND OF THE INVENTION

As is generally well known in the prior art, most people experience foot problems at some point during their lifetime. This is not surprising when one considers that numerous people are employed in jobs that require them to be on their feet quite often. It is also a known fact that even an average day of walking can exert force substantially equal to several hundred tons of pressure on the feet.

Bathing of the feet has become a recognized therapeutic method in an attempt to alleviate a wide variety of podiatric problems. For example, soaking soothes the feet as well as aiding in a quicker recovery from fatigue. Bathing of the feet also stimulates the circulation of blood therethrough, which results in increased metabolism and excretion. In addition, foot bathing facilitates the removal of any painful growths on the feet such as calluses, bunions, and corns which frequently occur.

There are numerous types of foot baths which have been utilized as therapeutic devices for the feet. Typically, foot baths provide heated water which temperature is normally maintained via some type of electrical means. In addition, current foot baths often provide a means for massaging the feet through vibration. Vibratory massage enhances the therapeutic results achieved with soaking alone by further increasing circulation, as well as relaxing and massaging the muscles.

While heat and vibration applied to the feet in an overall manner is helpful. In fact, some conventional foot baths are now being designed with the capability to target specific areas of the feet. For example, it is common for a user to wish to concentrate treatment to a specific part or parts of his/her feet such as the ball, heel, or arch. Such a bath apparatus not only allows users to tailor therapy regimens to their individual needs, but it also increases the speed at which therapy can be accomplished, thereby increasing the convenience for the user.

None of these prior art devices however have an appealing look to the user while they are caring for their feet.

### SUMMARY OF THE INVENTION

The present invention provides, in a first aspect, an apparatus for at least one of bathing and soaking a body part. The apparatus includes a bath chamber for containing a fluid and receiving such body part therein. Such bath chamber includes a bottom surface and a wall structure extending upwardly therefrom. Additionally, the apparatus includes a glitter like material disposed on at least one of said bottom surface, an inner surface of such wall structure and a combination thereof of the bath chamber.

In a second aspect, the present invention provides a foot bath having a generally U-shaped bath chamber for containing water and receiving at least one foot therein. The bath chamber includes a bottom surface and a wall structure extending upwardly therefrom and terminating in an upper surface that includes a peninsular contact portion. A heating member is provided on the contact portion and arranged to be uncovered by water contained in the bath chamber for providing heat to a surface of such foot when it is placed on the contact portion. A glitter like material is disposed on at least one of such bottom surface, an inner surface of the wall structure and a combination thereof of the bath chamber.

### OBJECTS OF THE INVENTION

It is, therefore, one of the principal objects of the present invention to provide an apparatus for bathing body parts and providing targeted therapy, including heat and massage, to the body parts which has an appealing surface to look at while in use.

Another object of the present invention is to provide apparatus for bathing body parts which is more appealing to the user and will not add significantly to the manufacturing cost.

Still another object of the present invention is to provide an apparatus for bathing body parts which is more appealing to the user and will not alter the operation of the apparatus.

Yet another object of the present invention is to provide an apparatus for bathing body parts which is more appealing to the user and can be produced in a wide variety of shapes and colors.

A further object of the present invention is to provide an apparatus for bathing body parts which is more appealing to the user and may be retrofitted in one embodiment to existing apparatus.

In addition to the various objects and advantages of the present invention which have been enumerated above a number of other objects and advantages of the invention will become more readily apparent to those persons who are skilled in the relevant art from the following more detailed description of the invention, particularly, when such description is taken in conjunction with the attached drawing figures and with the appended claims.

### BRIEF DESCRIPTION OF DRAWINGS

FIG. 1 is a perspective view of a bath apparatus constructed in accordance with the present invention;

FIG. 2 is a top plan view of the bath apparatus of FIG. 1;

FIG. 3 is a side elevational view of the bath apparatus of FIG. 1, wherein the wall structure is partially cut away to show a user's foot engaging the contact portion;

FIG. 4 is a fragmentary view of the pump, heating, and vibration assemblies located on the underside of the bath chamber;

FIG. 5 is a perspective view of a second embodiment of the bath apparatus according to the present invention; and

FIG. 6 is a top plan view of the bath apparatus of FIG. 5.

### BRIEF DESCRIPTION OF A PRESENTLY PREFERRED AND VARIOUS ALTERNATIVE EMBODIMENTS OF THE INVENTION

Prior to proceeding to the more detailed description of the present invention, it should be noted that identical components having identical functions have been identified with identical reference numerals throughout the several views illustrated in the drawing figures for the sake of clarity.

Refer now, more particularly, to the drawings. Illustrated therein is a bath apparatus constructed according to the present invention, generally designated 10. Bath apparatus 10 can be used to provide heat, massage, bubbles, and combinations thereof to body parts, such as the feet. Bath apparatus 10 is preferably constructed from a plastic material so as to be lightweight and portable, as well as durable, leakproof, and corrosion resistant. Although bath apparatus 10 is illustrated and described herein as being particularly adaptable for use as a foot bath, it is understood that bath apparatus 10 of the present invention may be used for bathing other body parts, such as the hands.

With reference to FIG. 1, there is illustrated one presently preferred embodiment of the invention in which a bath apparatus, generally designated 10, includes a bath chamber, generally designated 12, for containing a fluid, such as water, and receiving at least one body part, such as the foot, therein. Bath chamber 12 includes a bottom surface 14 and a wall structure 16 extending upwardly therefrom. Wall structure 16 terminates in an upper surface 18 that includes a contact portion 20 adapted to be exposed when water is contained in bath chamber 12. Bottom surface 14 can be generally parallel to a supporting surface on which bath apparatus 10 is placed or, alternatively, bottom surface 14 could be slanted downwardly toward the user.

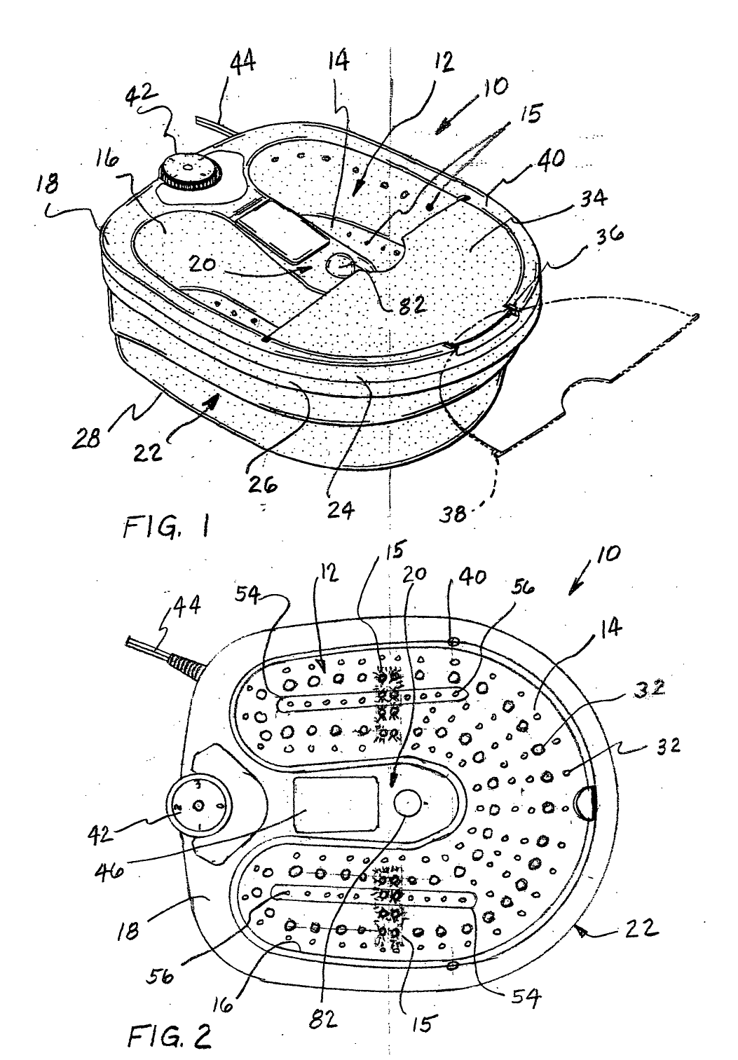

Bath chamber 12 is of a length and width to accommodate the feet of an adult user, such that sufficient space is provided to permit the user to readily insert and remove his/her foot and to allow the foot to be moved about slightly while in position within bath chamber 12. As illustrated in FIGS. 1 and 2, bath chamber 12 is generally U-shaped and a contact portion, generally designated 20, is generally peninsular and centrally disposed within bath chamber 12. With this configuration, a user's feet are received on either side of peninsular contact portion 20, wherein the feet are spaced apart sufficiently to provide comfortable placement. For use, bath chamber 12 is filled with water such that a user, preferably seated, submerses his/her feet up to approximately the height of the ankles. A user can then easily remove his/her foot for placement on contact portion 20 for targeted therapy as described below. Of course, it is understood that contact portion 20 can have any location on bath apparatus 10 which remains uncovered by water and is accessible to the user.

Disposed on at least one of the bottom inner surface 14 and the inner surface of sidewall structure 16 is glitter 15 for enhancing the attractiveness of the bath apparatus 10.

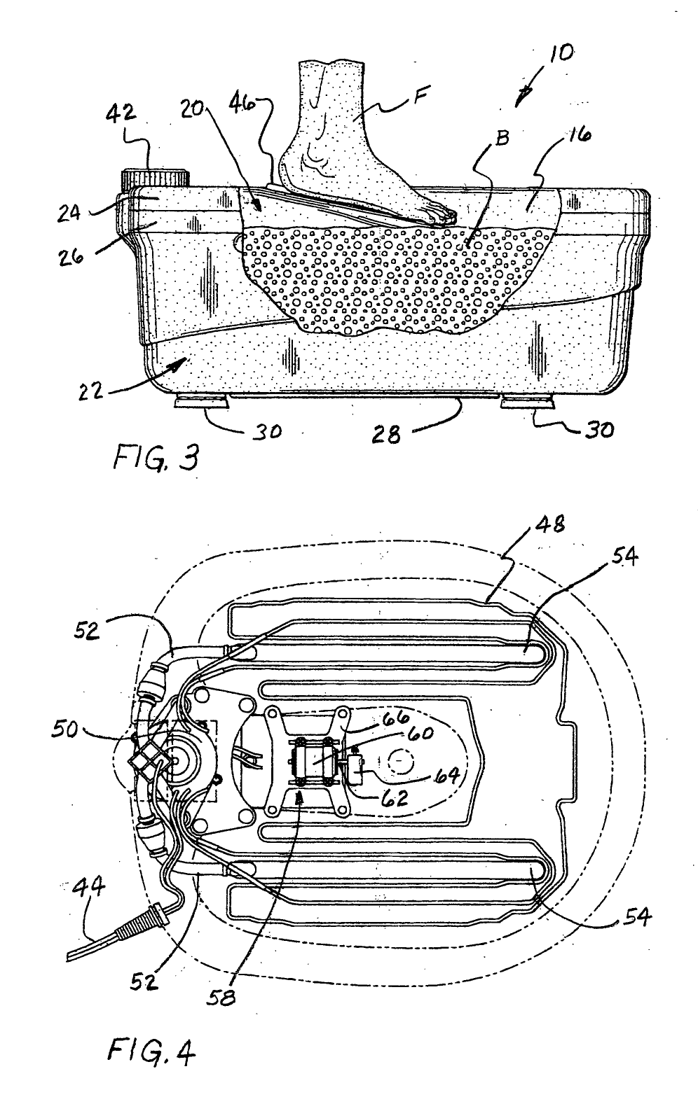

An outer housing, generally designated 22, is provided to encase bath chamber 12, wherein outer housing 22 is spaced from bath chamber 12 to provide a location for housing the various mechanical/electrical assemblies of bath apparatus 10, as described below with reference to FIG. 4. As best shown in FIGS. 1 and 3, upper surface 18 of bath chamber 12 includes a downwardly extending flange 24 which aligns with an upwardly extending flange 26 of outer housing 22. Flanges 24, 26 are secured together by screws (not shown) to fix bath chamber 12 in position with respect to outer housing 22. The base 28 of outer housing 22 is preferably provided with feet 30 constructed from a material such as rubber to prevent movement of the bath apparatus 10 along a supporting surface.

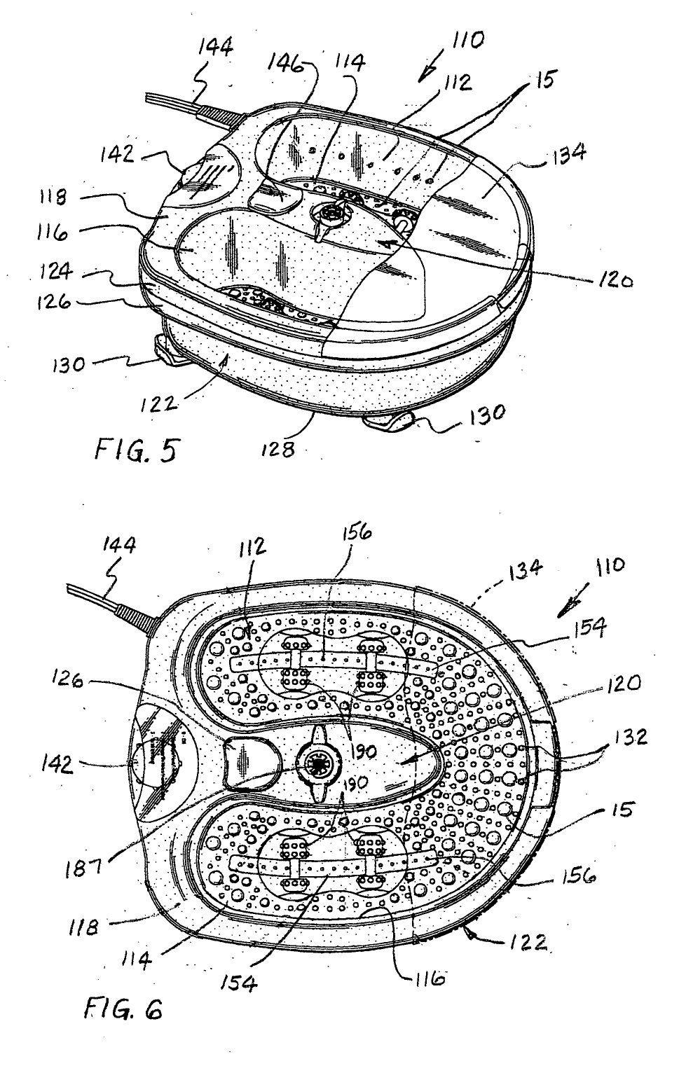

Referring again to the top plan view of FIG. 2, bottom surface 14 of bath chamber 12 preferably includes a plurality of raised nodes 32 which can be of varying sizes. Nodes 32 function to massage the feet upon contact, and also allow water and heat to flow under the feet to improve blood circulation. As shown in FIGS. 1 and 2, bath apparatus 10 further includes a lid 34 adapted to be attached to wall structure 16 to at least partially cover bath chamber 12. As shown, lid 34 is attached to wall structure 16 by a hinge 36, and includes tabs 38 that are securely received in corresponding openings 40 provided on wall structure 16. Therefore, as shown in FIG. 1, lid 34 can be positioned to partially cover bath chamber 12 to prevent any accidental splashing of water, or lid 34 can be rotated away from bath chamber 12 about hinge 36 for ease of inserting and removing the feet and filling bath chamber 12 with water. Alternatively, as shown in the embodiment of FIGS. 5-6, lid 134 can simply snap fit over wall structure 16 to be completely removable. Lid 34 is preferably constructed from a plastic material, and is sufficiently rigid so that it can be used as a foot rest when only one foot is being submersed within bath chamber 12.

Referring again to FIGS. 1-3, a selector 42 is located on upper surface 18 of bath chamber 12, wherein selector 42 is rotatable by a user to selectively provide various combinations of heat, massage, and bubbles to the feet. Wiring interconnects selector 42 with each of the mechanical/electrical assemblies described below which are then powered via connection of a standard power cord 44 to any 110 V AC outlet. In a presently preferred embodiment, selector 42 can be set to provide three different combinations of bath functions: 1) vibration massage, chamber heat, and targeted infrared heat; 2) vibration massage, bubbles, chamber heat, and targeted infrared heat; and 3) bubbles and chamber heat. However, it is understood that other combinations are fully contemplated in accordance with the present invention.

With further reference to FIGS. 1-4, the several mechanical/electrical assemblies of bath apparatus 10 of the present invention will now be described. Each of the following assemblies is housed in the space between bath chamber 12 and outer housing 22 and is selectively powered as determined by the setting of selector 42. First, a heating member 46 is provided on contact portion 20 for providing heat to the foot surface when the foot F is placed on contact portion 20. Advantageously, heating member 46 provides the capability of focusing heat on the specific region of the foot desired by the user. According to a preferred embodiment of the present invention, heating member 46 uses infrared rays. Infrared rays allow heat to penetrate deep underneath the surface of the skin, causing the pores of the skin to be opened and promoting metabolism and excretion of the body through increased blood circulation. The applied pressure of the foot on heating member 46 can be adjusted by the user for optimum comfort. Although the surface of heating member 46 is shown herein to be generally flat, heating member 46 could have any contour suitable for contact with a user's foot.

In addition to heating member 46, a heater is provided in communication with bath chamber 12. As best shown in FIG. 4, the heater preferably includes a rope heating element 48 secured underneath bottom surface 14 of bath chamber 12. Upon receiving electrical power, as determined by selector 42, rope heating element 48 is operable to conduct heat to the water contained within bath chamber 12. The heated water maintained by rope heating element 48 relieves tired muscles and promotes circulation of the blood. Rope heating element 48 is positioned to wind back and forth to substantially cover bath chamber bottom surface 14. Rope heating element 48 preferably includes insulated conducting wires, wherein the conductive materials are capable of transmitting heat to bath chamber bottom surface 14 without generating temperatures that exceed the melting point of the plastic material used to construct bath apparatus 10.

Bath apparatus 10 further includes a pump 50 in communication with bath chamber 12 for directing air into bath chamber 12 to generate air bubbles in the water contained therein. As shown in FIG. 4, pump 50 forces air through outlet tubes 52 which are connected to bubble egress strips 54 formed in bath chamber bottom surface 14. Air is then forced out of a plurality of egress holes 56 provided in bottom surface 14 along each bubble egress strip 54 to form bubbles B in the water contained in bath chamber 12 as illustrated in FIG. 3. Although bubble egress strips 54 are shown herein as being linear in shape, any configuration of bubble egress strips 54 and corresponding egress holes 56 suitable for generating bubbles in bath chamber 12 can be used in accordance with the present invention.

Still further, bath apparatus 10 includes a vibration assembly 58 in communication with bath chamber 12 for imparting vibration to bath chamber 12 to provide a massaging effect to the feet. Vibration assembly 58 includes a motor 60 affixed to an underside of bath chamber 12, an output shaft 62 rotatably driven by motor 60, and a counterweight 64 affixed to output shaft 62. Vibration assembly 58 is affixed underneath a central portion of bath chamber 12 by a motor support bracket 66. When motor 60 is electrically powered, rotation of output shaft 62 and attached counterweight 64 imparts vibrations to motor support bracket 66, and these vibrations are then transferred to bath chamber 12 and the water contained therein in order to massage the feet. It is fully contemplated that variable vibration intensities could be provided in accordance with the present invention.

FIGS. 5-6 illustrate a second embodiment of the bath apparatus, generally designated 110, according to the present invention, which operates substantially similarly to bath apparatus 10 except for the additional motorized massage and bottom surface features described below. The reference numerals for FIGS. 5-6 correspond generally with the reference numerals for FIGS. 1-4 except for the addition of a “1” prefix.

Bath apparatus 110 includes a contact portion 120 for receiving massage attachments 184, 185, 186 wherein rotation of massage attachments 184, 185, 186 is motorized.

Referring now to FIG. 6 bath apparatus 110 further includes a bottom surface 114 which can include rollers 190 provided thereon. A user can glide his/her foot back and forth across rollers 190 to help relieve tightness and tiredness along soles of feet, as well as for reflexology purposes. Rollers 190 include raised massage nodes, and are preferably rotatably attached to a roller plate, which is detachable from bottom surface 114.

It is noted that to achieve the greatest satisfaction to individual users, glitter 15 may be provided so that the user may decorate the apparatus 10, 110 in any manner they so desire.

In summary, bath apparatus 10, 110 of the present invention provides the capability to target specific areas of the body with therapeutic heat and massage. Therefore, bath apparatus 10, 110 allows users to tailor therapy regimens to their individual needs, and also increases the efficiency of therapy sessions due to the concentration of heat and massage at desired locations.

Accordingly, an apparatus is provided for bathing body parts, such as the feet or hands. The bath apparatus includes a bath chamber for containing fluid, such as water, and receiving the body part therein. The bath chamber includes a bottom surface and a wall structure extending upwardly therefrom, wherein the wall structure has a contact area adapted to be uncovered by fluid contained in the bath chamber. A heating member is provided on the contact area for providing heat to the body part when the body part is placed on the contact area.

According to one embodiment of the present invention, the heating member uses infrared rays. In addition, a heater is provided in communication with the bath chamber for maintaining the heat of the fluid contained therein. Preferably, the heater includes a rope heating element provided underneath the bottom surface of the bath chamber. Furthermore, the bath apparatus includes a pump in communication with the bath chamber for directing air into the bath chamber to generate air bubbles in the fluid contained within the bath chamber, wherein air flows through a plurality of holes provided in the bottom surface of the bath chamber. Still further, the bath apparatus includes a vibration assembly in communication with the bath chamber for imparting vibration to the bath chamber. The vibration assembly includes a motor affixed to an underside of the bath chamber, an output shaft rotatably driven by the motor, and a counterweight affixed to the output shaft.

In further accordance with the present invention, the bath apparatus includes at least one massage attachment adapted to be received on the contact area for massaging the body part when the body part engages the massage attachment. The massage attachment can be stationary, or can be manually rotatable by a user. Alternatively, rotation of the massage attachment can be motorized. In this embodiment, a motor is disposed on the underside of the bath chamber, and the massage attachment is adapted to be received on an output shaft that is rotatably driven by the motor and adapted to be accessible through the contact area. Optionally, the motorized rotation of the massage attachment can be activated by applied pressure of the body part on the massage attachment.

Preferably, a plurality of different massage attachments are provided. The massage attachments can include, for example, attachments with raised nodes, a roller, a pumice stone, and a brush. A storage unit is provided which is adapted to be attached to the wall structure for storing the one or more massage attachments therein.

According to the present invention, an outer housing is provided to encase the bath chamber. Preferably, the bath chamber is generally U-shaped and the contact area is generally peninsular, such that the contact area is centrally disposed within the bath chamber. The bath chamber preferably includes a plurality of raised nodes provided on its bottom surface. Additionally, the bottom surface of the bath chamber can include rollers provided thereon, wherein the rollers can be detachable from the bottom surface. The bath apparatus can also include a lid adapted to be attached to the wall structure to at least partially cover the bath chamber.

The above objects and other objects, features, and advantages of the present invention are readily apparent from the following detailed description of the best mode for carrying out the invention when taken in connection with the accompanying drawings.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. An apparatus for at least one of bathing and soaking a body part, said apparatus comprising:
a bath chamber for containing a fluid and receiving such body part therein, said bath chamber including a bottom surface and a wall structure extending upwardly therefrom; and
a glitter like material disposed on at least one of said bottom surface, an inner surface of said wall structure and a combination thereof of said bath chamber.

2. An apparatus according to claim 1, wherein said apparatus further includes a heating member disposed on said apparatus for providing heat to such fluid contained in said bath chamber.

3. The apparatus according to claim 2, wherein said heater member includes a heating element provided underneath said bottom surface of said bath chamber.

4. The apparatus according to claim 1, wherein said apparatus further includes an air pump in communication with said bath chamber for directing air into said bath chamber to generate air bubbles in such fluid contained therein.

5. The apparatus according to claim 1, wherein said apparatus further includes a vibration assembly in communication with said bath chamber for imparting vibration to said bath chamber.

6. The apparatus according to claim 1, wherein said apparatus further includes at least one massage attachment for massaging such body part when it engages said massage attachment.

7. The apparatus according to claim 6, wherein said at least one massage attachment is stationary.

8. The apparatus according to claim 7, wherein said at least one massage attachment includes a roller.

9. The apparatus according to claim 1, wherein said apparatus further includes a plurality of raised nodes on said bottom surface of said bath chamber and said glitter like material is disposed at least one of on and between said raised nodes.

10. The apparatus according to claim 1, wherein said apparatus further includes a lid adapted to be attached to said wall structure to at least partially cover said bath chamber.

11. The apparatus according to claim 1, wherein said apparatus further includes an outer housing which encases said bath chamber.

12. A foot bath, comprising:
a generally U-shaped bath chamber for containing water and receiving at least one foot therein, said bath chamber including a bottom surface and a wall structure extending upwardly therefrom, said wall structure terminating in an upper surface that includes a peninsular contact portion;
a heating member provided on said contact portion, said heating member arranged to be covered by water contained in said bath chamber for providing heat to a surface of such foot when it is placed on said contact portion; and
a glitter like material disposed on at least one of said bottom surface, an inner surface of said wall structure and a combination thereof of said bath chamber.

13. The foot bath according to claim 12, wherein said foot bath further includes a heater provided underneath said bottom surface of said bath chamber for maintaining heat of such water contained within said bath chamber.

14. The foot bath according to claim 12, wherein said foot bath further includes an air pump in communication with said bath chamber for directing air through a plurality of holes provided in said bottom surface of said bath chamber to generate air bubbles in such water contained therein.

15. The foot bath according to claim 12, wherein said foot bath further includes a vibration assembly in communication with said bath chamber for imparting vibration to said bath chamber.

16. The foot bath according to claim 18, wherein said foot bath further includes at least one massage attachment for massaging a foot surface when such foot surface engages said massage attachment.
